(19) United States
(12) Patent Application Publication
(10) Pub. No.: US 2011/0273917 A1
(43) Pub. Date: Nov. 10, 2011

(54) INTELLIGENT PHOTOVOLTAIC INTERFACE AND SYSTEM

(75) Inventors: Arindam Maitra, Charlotte, NC (US); Mark McGranaghan, Knoxville, TN (US); Satish Rajagopalan, Knoxville, TN (US); Jih-Sheng Lai, Blacksburg, VA (US)

(73) Assignee: ELECTRIC POWER RESEARCH INSTITUTE, INC., Charlotte, NC (US)

(21) Appl. No.: 13/101,233

(22) Filed: May 5, 2011

Related U.S. Application Data
(60) Provisional application No. 61/331,597, filed on May 5, 2010.

(51) Int. Cl. H02M 7/68

(52) U.S. Cl. 363/74

(57) ABSTRACT

The present invention relates to a photo-voltaic interface for integration of photo-voltaic modules in a power system. The photo-voltaic interface includes a power conversion system adapted to convert power to a pre-determined voltage and current type, a control and monitoring system adapted to allow monitoring and control of power flow to optimize grid operation, and a communications system adapted to allow remote monitoring of the photo-voltaic interface to detect defective components.

This application claims the benefit of Provisional Application No. 61/331,597 filed on May 5, 2010.

### BACKGROUND OF THE INVENTION

The present invention relates generally to a photovoltaic interface and system, and more particularly to a photovoltaic interface that acts as both an inverter and distribution transformer.

In order to be considered a fully photovoltaic resource, the capability to inject direct current (DC) output from photovoltaic arrays or panels directly into alternating current (AC) power distribution systems is required. Presently, the installed cost of photovoltaic panels is about $8 to $9 per watt of installed capacity. However, only 40 to 50% of the cost lies in the solar panels themselves. The remaining cost lies in the installation and integration of solar panels to the grid. This integration cost is the result of complicated methods that must be used to connect distributed resources such as photovoltaic panels with a grid that is not designed to accommodate power flows from a user to the grid.

At present, DC power from photovoltaic (PV) modules is converted into AC power and fed into a power delivery grid through grid-tied inverters. Conventional integration techniques facilitate the connection of PV modules to the DC bus of an inverter through a boost DC-DC converter known as maximum power point tracker (MPPT) which feeds power to local loads. The output of the inverter can also be tied to the grid, allowing the PV modules to feed power to either the customers' loads or to a utilities' low voltage (LV) distribution grid through a distribution transformer (See FIGS. 1-4).

The MPPT converter inside the grid-tied inverter plays an important role to accommodate PV modules of various kinds. A photovoltaic cell produces load dependent output voltage having a voltage magnitude that may be affected by illumination level and temperature. Therefore, the output voltage of a PV module can vary within a wide range. Thus, each PV module has its own set of current/voltage (I/V) curves. When the connected load is varied, the operating and power points shift. This is why the maximum power may not be harvested from the PV module when a fixed load is connected to it. However, when the PV module is connected to the grid, the PV module may be operated at a maximum power point utilizing the power grids unique nature and the MPPT converter. FIG. 5 shows MPPT operation of a PV module.

For a fixed illumination level and temperature, the panel will have a single I/V curve and one maximum power point. At this point, the voltage produced by the panel is known as VMP (voltage at maximum power) and the voltage at zero current is termed as VOC. A PV module produces the maximum current (ISC) when its terminals are short circuited.

Inverters add cost and introduce a set of conversion losses which are parasitic to the overall effectiveness of photovoltaics as a renewable resource. In addition, traditional PV inverter/controllers do not provide services such as reactive power compensation and active filtering and line voltage regulation, which could be extremely valuable to grid operation. Further, conventional distribution transformers suffer from drawbacks such as poor energy conversion efficiency at partial loads, the use of liquid dielectrics that can result in costly cleanups in the case of spills, and a limitation of providing only one function—stepping voltage. Also, because these transformers have historically been designed for use as a passive system component, they do not provide real-time voltage regulation, offer limited monitoring capabilities, and do not incorporate a communication link for use as a distribution system monitoring node as part of a larger system-level monitoring and automation capability. At the same time, these transformers require costly spare inventories for multiple unit ratings, do not allow supply of three-phase power from a single-phase circuit, and are not parts-wise repairable. The conventional integration approach through the distribution transformer does not enable power flow to be conveniently and economically monitored and controlled for optimal grid operation, thereby impeding the development and grid integration of distributed generation systems, including PV systems.

Another recently developed approach in inverter design is the Z-source inverter. Inside a Z-source inverter, a passive LC circuit is used as a front-end buffer circuit for the inverter. Although there is no active device used in the LC circuit, it can provide DC voltage boosting and could work as an MPPT circuit for PV applications. Another big advantage of the Z-source inverter is the dual nature of the inverter. By choosing the inductor and capacitor value appropriately in the front end LC circuit, the overall inverter can be operated in a voltage-source or current-source configuration. The DC voltage gain is controlled by the duty cycle control inside the inverter. FIG. 6 shows a schematic of a Z-source inverter.

In spite of having many desirable features, Z-source inverter technology is very recent and not yet commercially available. In addition, the number of parts used in the LC circuit may be an impeding factor in the reliability of a Z-source inverter.

The rapidly rising costs of conventional transformers, the need for reducing the size and weight of magnetic components, the need for distribution automation and monitoring to improve reliability, the requirements for new services, and the need to meet customers' power quality and reliability requirements have driven the need for innovative solutions.

Accordingly, there is a need for a photovoltaic interface that would simultaneously upgrade grid capabilities and significantly increase the value of photovoltaic modules while reducing the actual cost of labor and equipment.

### BRIEF SUMMARY OF THE INVENTION

These and other shortcomings of the prior art are addressed by the present invention, which provides a power-electronic (PE) replacement that serves as both the inverter and the distribution transformer to make integration of PV panels simpler, more efficient, and more cost-effective, thereby enhancing market penetration of PV systems in the United States.

According to one aspect of the present invention, a photo-voltaic interface includes a power conversion system adapted to convert power to a pre-determined voltage and current type; a control and monitoring system adapted to allow monitoring and control of power flow to optimize grid operation; and a communications system adapted to allow remote monitoring of the photo-voltaic interface to detect defective components.

According to another aspect of the present invention, an intelligent photo-voltaic (PV) interface system includes a utility grid adapted to provide AC power; a PV array adapted to provide DC power; and a photo-voltaic interface adapted to provide a direct interface with the PV array and the utility grid.

### BRIEF DESCRIPTION OF THE DRAWINGS

The subject matter that is regarded as the invention may be best understood by reference to the following description taken in conjunction with the accompanying drawing figures in which:

FIGS. 1-4 show prior art PV modules integrated with a grid through a conventional inverters;

FIG. 5 is a graph showing characteristics of a PV-module;

FIG. 6 shows a prior art PV integration using a Z-source inverter;

FIG. 7 shows integration of PV modules with an IGCSI according to an embodiment of the invention;

FIG. 8 is a block diagram of the IGCSI of FIG. 7;

FIG. 9 shows the IGCSI of FIG. 7 interfaced with solar, energy storage, and fast charging;

FIG. 10 shows system power topology of the IGCSI of FIG. 7;

FIGS. 11-15 show modes of operation for the IGCSI of FIG. 7; and

FIGS. 16-21 show energy storage operational modes for the IGCSI of FIG. 7.

### DETAILED DESCRIPTION OF THE INVENTION

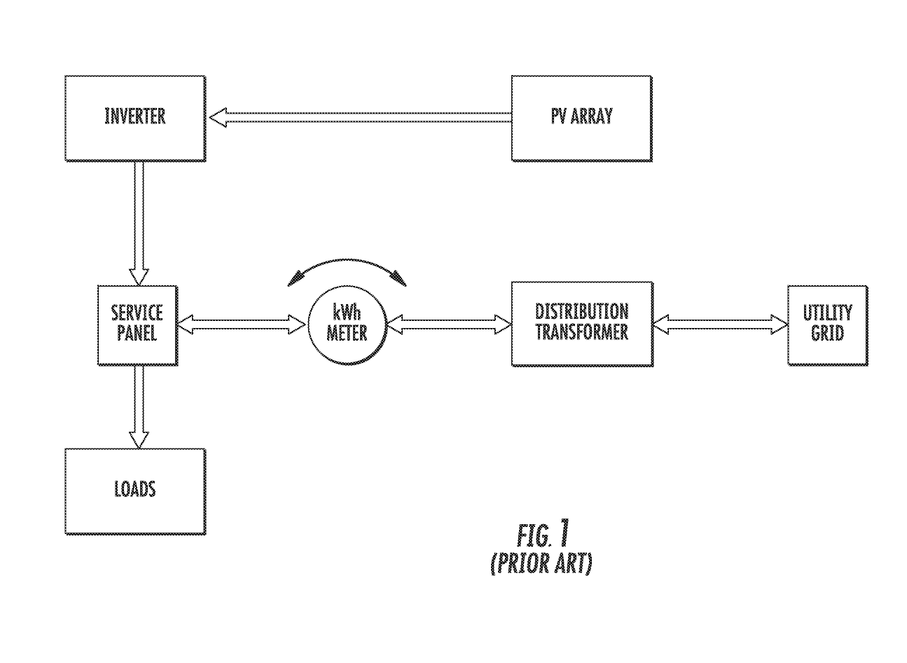

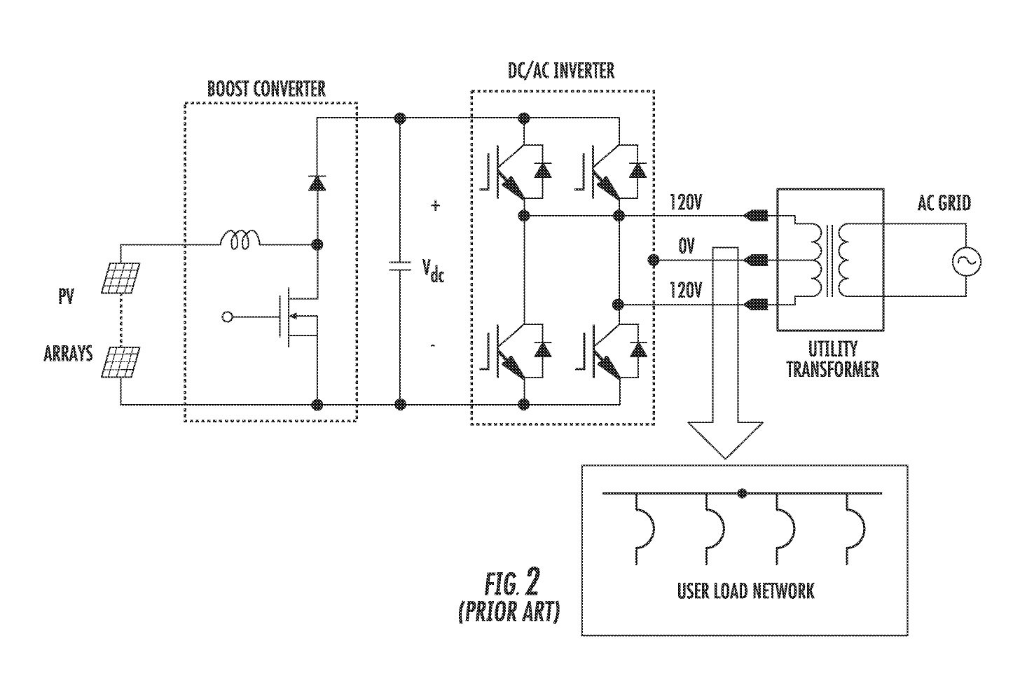

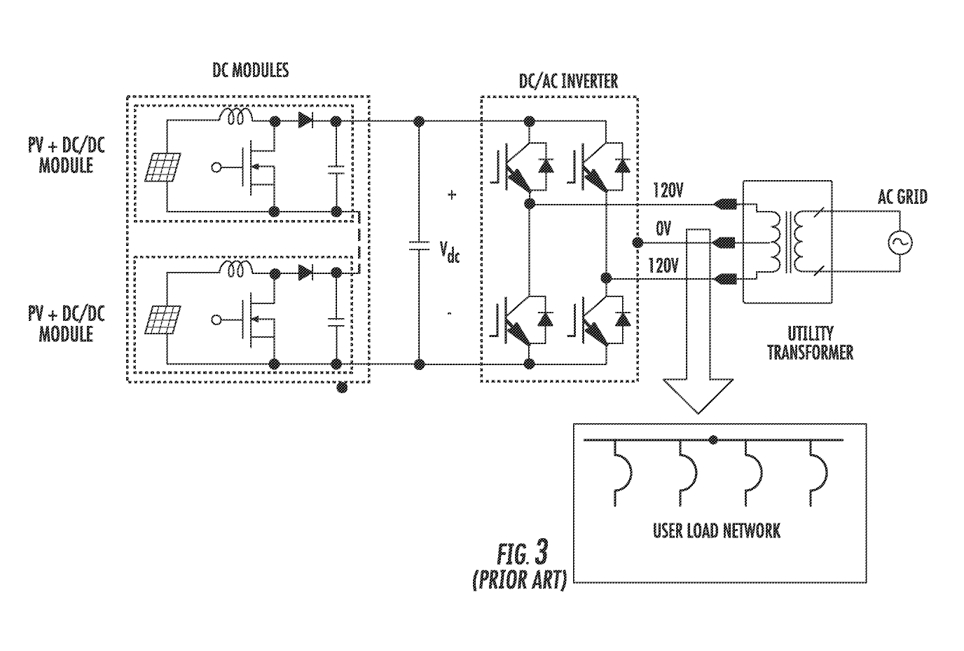

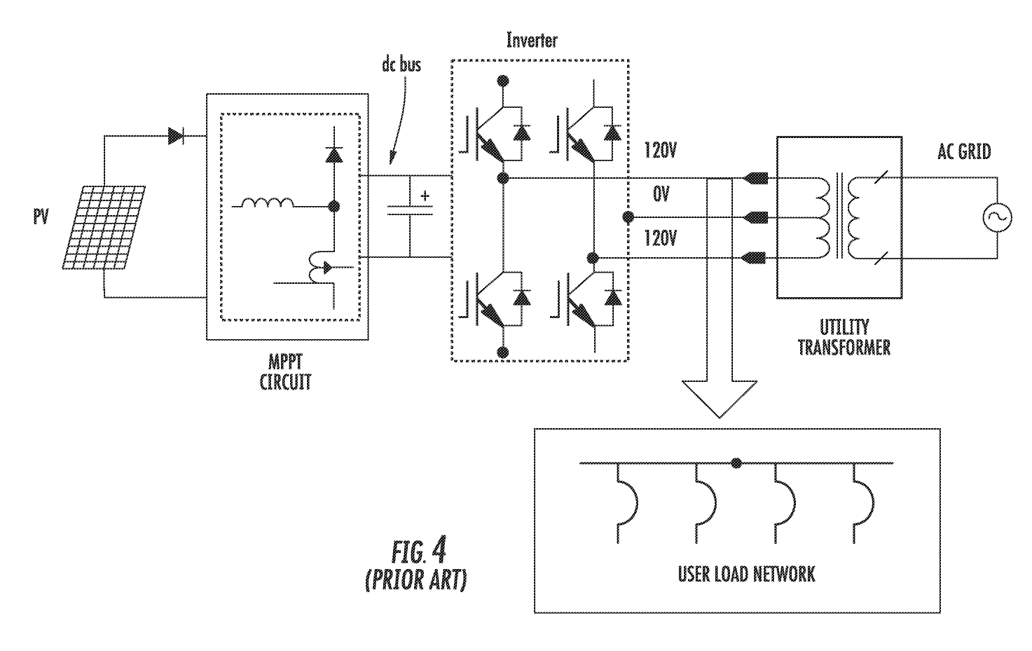

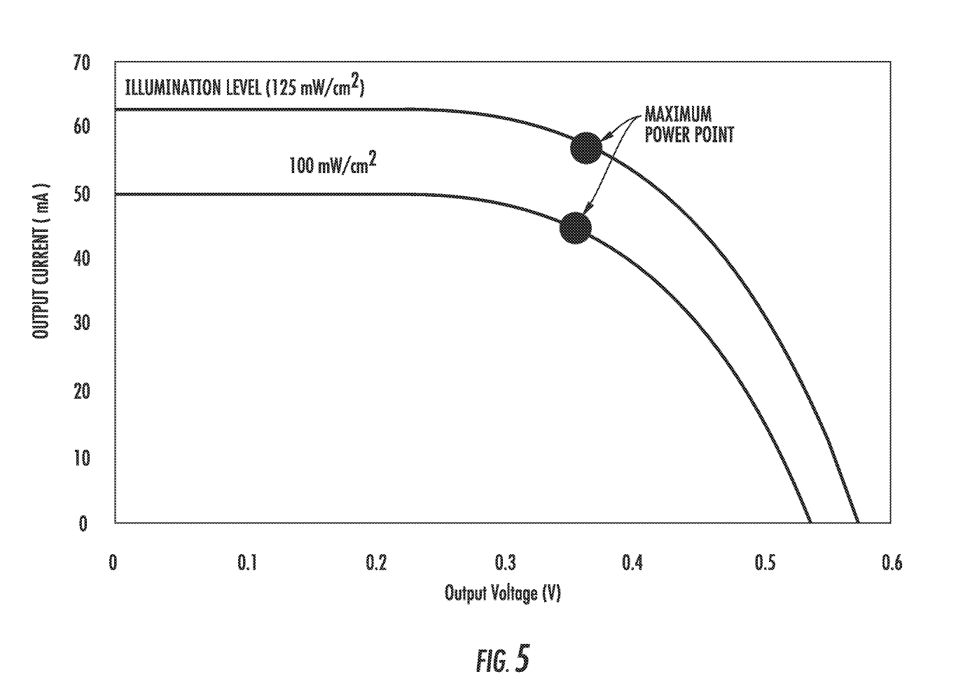

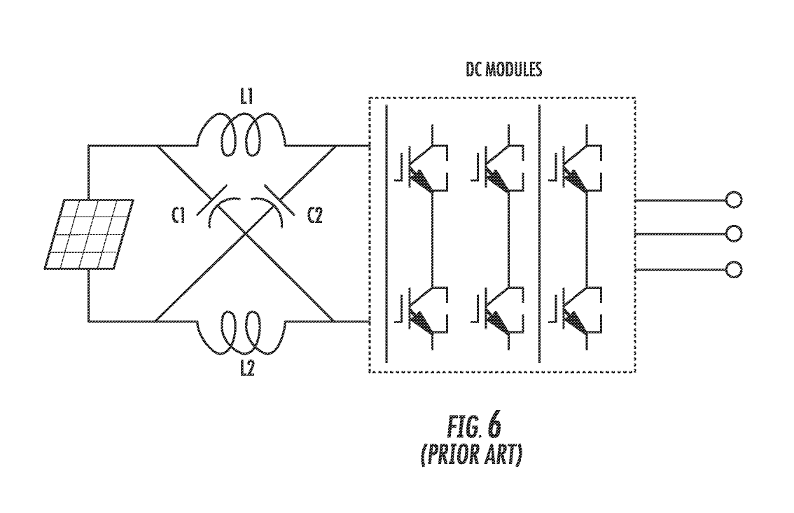

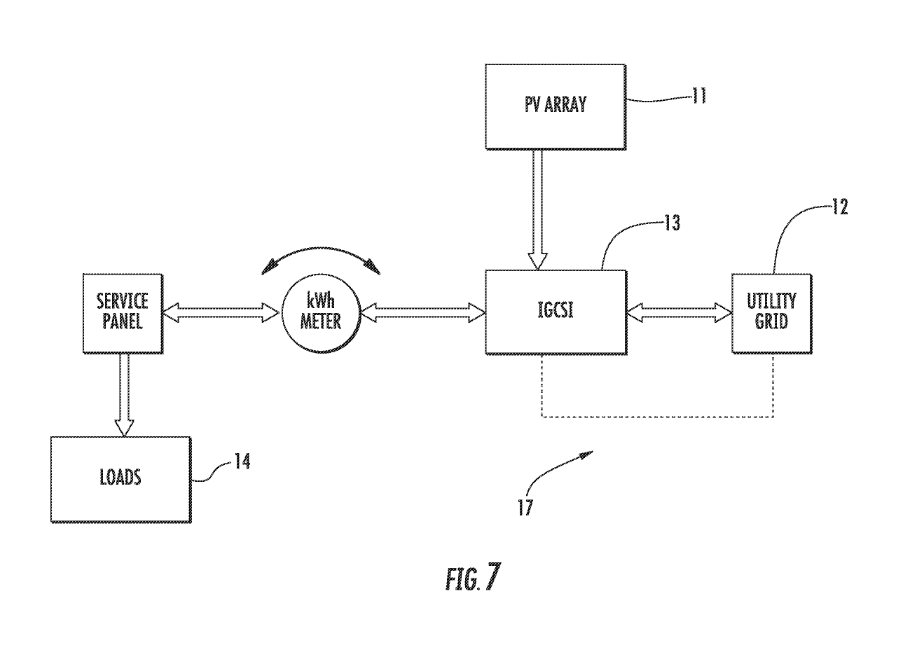

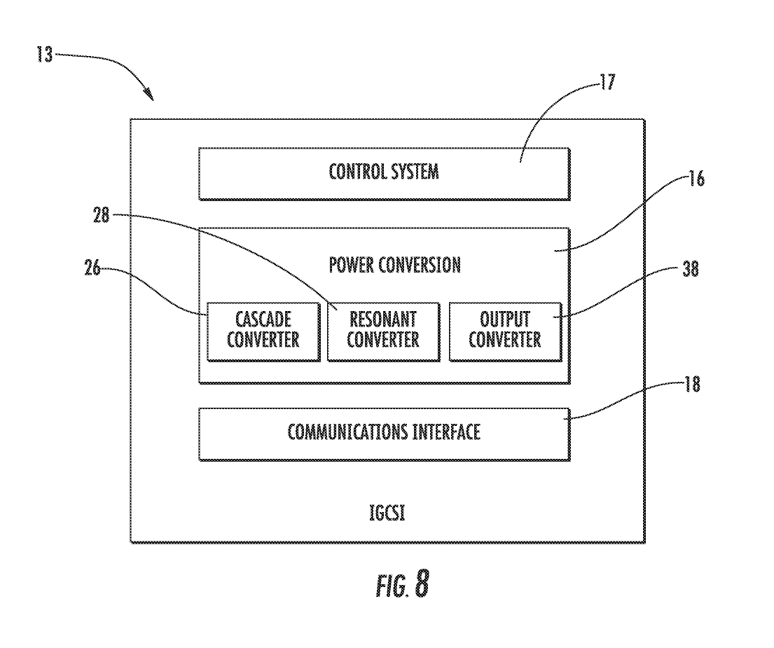

Referring to the drawings, an exemplary photovoltaic (PV) interface system according to the present invention is illustrated in FIG. 7 and shown generally at reference numeral 10. The system 10 integrates a PV system or array 11 with a utility grid 12 from both a power standpoint and a controls standpoint using a photo voltaic interface (intelligent grid-connected solar inverter (IGCSI)) 13 which replaces both a conventional solar inverter and a distribution transformer (both shown in FIGS. 1-4), thereby producing a single power-electronics based solution that allows simple integration while providing additional functionality to both a user or load 14 and the grid 12. The IGCSI 13 includes power conversion circuitry 16, a control and monitoring system 17 that allows seamless integration with utility controls and automations systems, and a communications interface 18. See FIG. 8.

The IGCSI 13 may be used as a solution to systems where utility distribution transformers, PV integration, energy storage, plugin hybrids, and additional services such as reactive power compensation, active filtering and line voltage regulation are involved. The IGCSI 13 provides these services (i.e., reactive power compensation, active filtering, and line voltage regulation) which are currently provided by the utility to the grid; thus, providing increased value and ease of integration of distributed resources to the grid.

Further, the IGCSI 13 is an intelligent, solid-state power converter that allows conversion of AC power at various voltages to DC or AC power at lower or higher voltages as necessary. This means that a single version of the IGCSI can replace conventional transformers of various ratings, reducing the necessity of maintaining a large, costly inventory of spares. The IGCSI is functionally capable of real-time voltage regulation at little additional cost relative to the basic voltage transformation function. The IGCSI further incorporates the capability of interfacing directly to distributed renewable systems operating at DC voltages, such as photovoltaic modules. The power conversion circuitry 16 of the IGCSI 13 converts ac power at low-voltage distribution voltages to 120/240 VAC for the home; DC power from PV modules to 120/240 VAC for home consumption; DC power from PV modules to low-voltage distribution voltage for export to a power network.

The control and monitoring system 17 incorporates sophisticated control circuitry that allows monitoring and control of power flow to optimize grid operation. This allows distribution system monitoring to support the needs of real-time advanced distribution automation and asset management.

The communications interface 18 allows remote monitoring of the IGCSI 13 itself to detect problems with components of the inverter, so that a service or repair action can be taken before the problem becomes severe enough to cause loss of the entire unit. This improves the reliability of the individual unit and increases the availability of solar power integration via an IGCSI 13 unit.

The same interface may also be used to extract information on voltage, current, power factor, temperature, and other parameters that may be used in operating the power distribution system and in asset management. This capability allows significant savings in the form of avoided cost in circumventing the need for many of the standalone sensors that would otherwise be needed to support future advanced distribution automation.

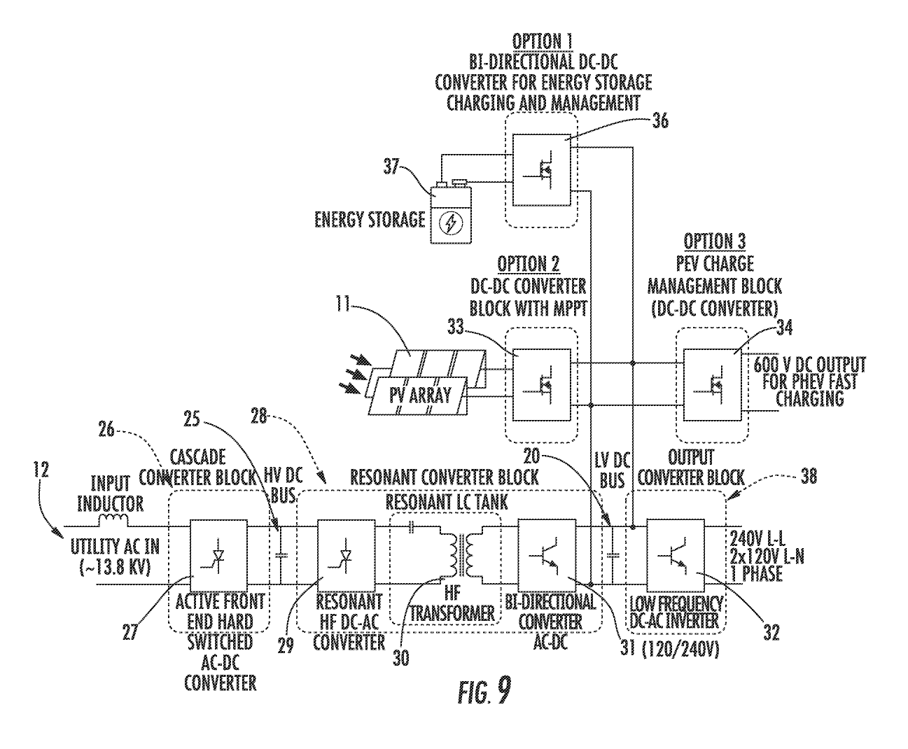

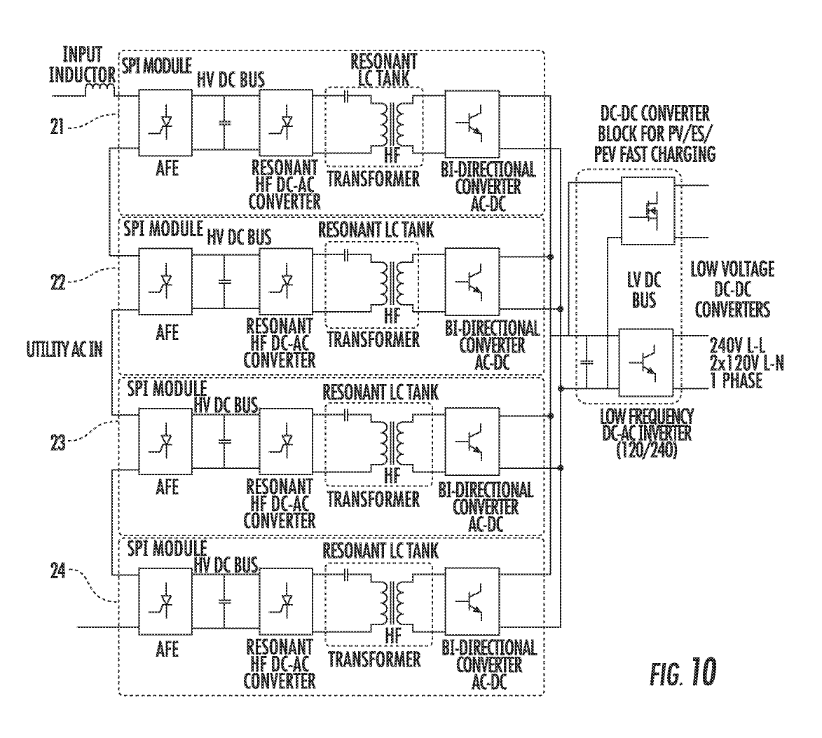

Referring to FIGS. 9 and 10, the IGCSI 13 can feed power directly to either a high 25 or low 20 voltage distribution bus. By virtue of the power electronic architecture, the IGCSI 13 includes provisions for multiple DC voltage nodes to directly integrate PV modules (See FIG. 10) in the IGCSI 13 based system 10. Thus, it is possible to integrate PV modules in the IGCSI 13 based system 10 in various configurations, such as hybrid power electronic transformer designs and solid-state based power electronic transformer designs.

The IGCSI 13 works with utility grids of today and provides a bridge towards utility grids of the future by seamlessly accommodating two-way power flows as required by wide-scale deployment of solar resources, energy storage, and plug-in hybrids. All power conversion circuitry blocks 16 are integrated in a single IGCSI 13, and the PV can be connected to the IGCSI 13 in various ways. The IGCSI 13 is a complete replacement for distribution transformers that has the benefits of reliability, power quality management, and distributed resource integration in addition to voltage control.

The IGCSI 13 combines a novel current-mode resonant conversion circuit using a SuperGTO (SGTO) device with silicon-carbide (SiC) based Schottky diodes. This approach allows lower losses, higher reliability, lower stresses, and smaller and lighter equipment than if standard IGBT or power MOSFET solutions were used. It also allows the use of air-cooling to eliminate the expense and problems associated with liquid cooling.

The SGTO improves power density and cost by allowing switching frequencies as high as 50 kHz (compared to IGBT limitations of 20 kHz max). Conduction and switching losses for the SGTO are half that of IGBTs. SGTOs have lower thermal resistance than conventional IGBT and other power switching devices, allowing better thermal management and ultimately, a smaller, lighter, and more cost-effective package.

Several characteristics make the SGTO a superior device and device of choice for today's high power applications include: Based on most advanced IC foundry fabrication process—mass production, volume cost, consistent quality; Improved thinPak packaging technology for higher reliability; Rated for as high as 6 kA rms, with typical die BV's>6 kV; High di/dt ratings for Pulse power applications; Low loss & better thermal management—ideal for continuous power applications; High Reliability—Must for Utility applications; Compact and easy to Use—Good for Prime real estate installations; High speed—good for high frequency applications; Extreme ease in parallel and series connection—good for modular design; the use of thinPak SGTO increases module build yield to nearly 100% as all of the die shown can be power tested before assembly; gate drive requirements are an order of magnitude lower allowing SGTO gate drive circuits to fit comfortably in the module resulting in extremely low gate parasitics that further enhance switching performance. This also impacts costs in a major way since ETO and IGCT gate drives are a considerable cost burden; Turn-on gate drives are smaller than needed to turn on a single 20 A 600-volt MOSFET, which requires 75 nC at least 10 volts. In contrast, gate drive 10× over threshold for the 80 kA PSM80B containing eight of the die below needs only 50 nC (100 mA for 0.5 μs) at just over a volt—15 times less gate energy!

The absence of wire bonding inside the package leads SGTO devices to have 100 times the reliability of IGBT modules. The reliability has been further optimized through the use of SiC-based ThinPak anti-parallel diodes with almost no switching losses. The proposed power electronics approach is modular and scalable, providing quality, reliability, and economies of scale.

As shown, the invention uses a modular approach to the IGCSI 13. The power conversion circuitry 16 includes one or more modules 21-24. Each module of the respective modules 21-24 includes a cascade converter block 26 having a hard switched AC-DC converter 27 and a resonant converter block 28. The resonant converter block 28 includes a resonant HF DC-AC converter 29, a resonant LC Tank HF transformer 30, and a bi-directional AC-DC converter 31. Each of the modules is connected to the low voltage bus 20 and an output converter block 38 having at least one low frequency DC-AC inverter 32. As shown, each of the modules is connected to loads via a converter. As illustrated in FIG. 9, the modules may be connected to a 120/240V load, to DC-DC converters with MPPT 33 for connection to a PV Array 11, to DC-DC converters 34 for PHEV Fast Charging, and to bi-directional DC-DC converters 36 for energy storage charging and management using a storage device or battery 37.

Multiple cascaded, modulated H-bridges (the “Line Converter”), convert the 13.8 kV 60 Hz AC into a nominal 20 kV DC conversion at unity power factor. Isolation is provided using the series connected high frequency H-bridge resonant converters 29. The input stages of each of these converters are in series and the output stages are in parallel. Each resonant converter 28 output is a current source to the load so these are parallelable following rectification on to a single low voltage (e.g. 400V nominal for a 120/240V 60 Hz single phase output converter) bus capacitor 20 that in turn becomes the voltage source for transformerless solid state converters that produce desired combinations of 3 phase, single phase and/or DC outputs.

The resonant converter approach has many advantages over hard-switched or resonant-commutated switched. The primary discriminator is in the performance of the high voltage active switch devices that can be used. With zero turn on current and zero turnoff current and guaranteed dead time before reapplication of voltage all the switching losses of hard switched designs are virtually eliminated. Further SGTO devices with their low forward drops in relation to competing high voltage devices can be used.

Hard switched and resonant commutated topologies both require high frequency voltage transformers that must be designed for minimum leakage inductance to avoid high snubber losses in the primary switching circuit. This is in direct conflict with the need to provide a heavy dielectric barrier between windings to achieve the required galvanic isolation stand-off voltage. The configuration of resonant converter that uses the leakage inductance of the high frequency isolating transformer as the resonant circuit L is inherently suitable for high voltage isolation applications since the required leakage inductance makes it possible to use a substantial isolating layer between input and output windings. By contrast more conventional high frequency switching converters require transformers that minimize leakage inductance and introducing adequate insulation runs counter to this. The losses in the resonant approach are considerably lower.

Accordingly, some of the advantages of the IGCSI include a unity input power factor, a line filter reduced or eliminated, no 60 Hz transformer, a low frequency switching line converter, a low switching loss resonant converter, a galvanic isolation through small HF transformer, a load well isolated from grid variation, a tightly regulated load voltage, and a system having a modular approach.

The control system 17 inside the IGCSI 13 allows for the addition of control modules that add specific functionality and features, i.e.:
control interfaces and logic for distribution management, energy management and demand response systems (grid side);
control interfaces and logic for managing resource-side loads that are part of demand response, PV, electrical energy storage, and electric vehicles, especially EV fast-charging functionality;
islanding logic and functions that will, when appropriate, allow local systems to operate independently from the grid to improve reliability;
measurement and monitoring functions including metering, event data collection and filtering;
external monitoring, management and control protocols and associated communications modules.

The communications interface 18 allows for monitoring the inverter to assure it is performing properly, dispatching smart inverter functions, and using the inverter as a source of distributing system real-time operating data at the location of the inverter.

### Operational Modes (Example: PV Integration)

The IGCSI 13 is principally a power electronic transformer with direct interface to a PV source. The key feature of this inverter 13 is the ability to direct interface renewable energy sources such as PV while also serving as a distribution transformer. Depending upon where the PV array 11 is to be integrated, two topologies are possible, as shown in FIG. 9. All the power stages of this inverter 13 can facilitate bi-directional power flow through switching of semiconductor devices in the converter.

The IGCSI 13 is multi-functional and can facilitate power flow in several schemes depending upon the availability of the distributed resource and the instantaneous load level. The example of a PV interface is presented here.

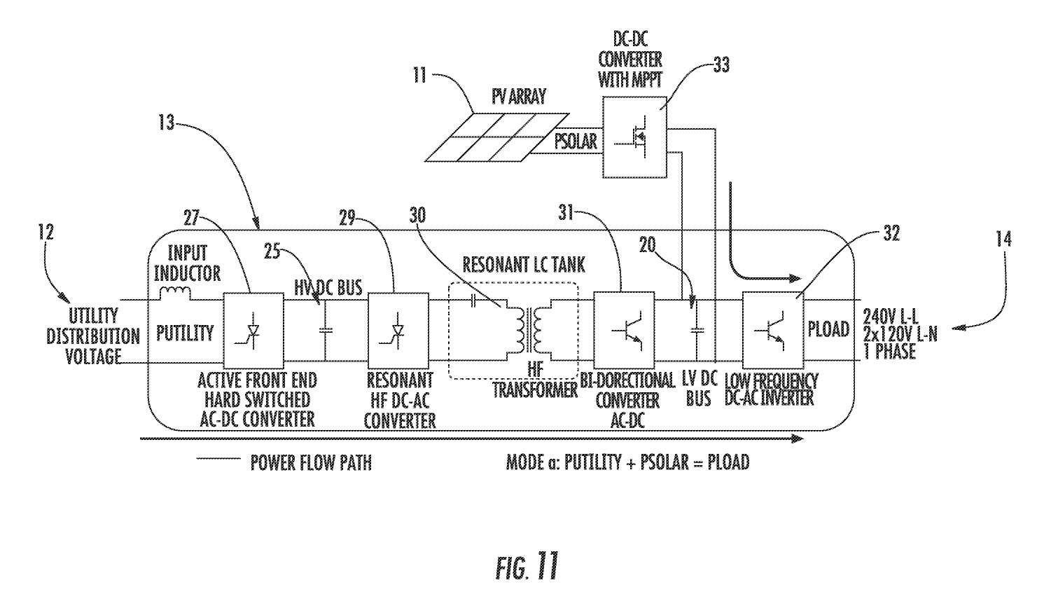

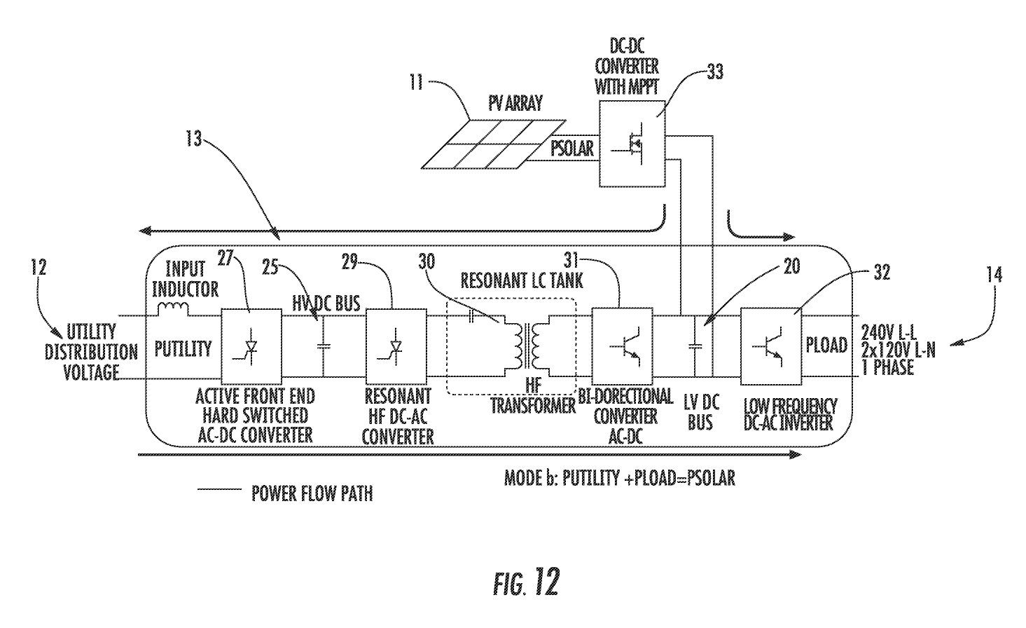

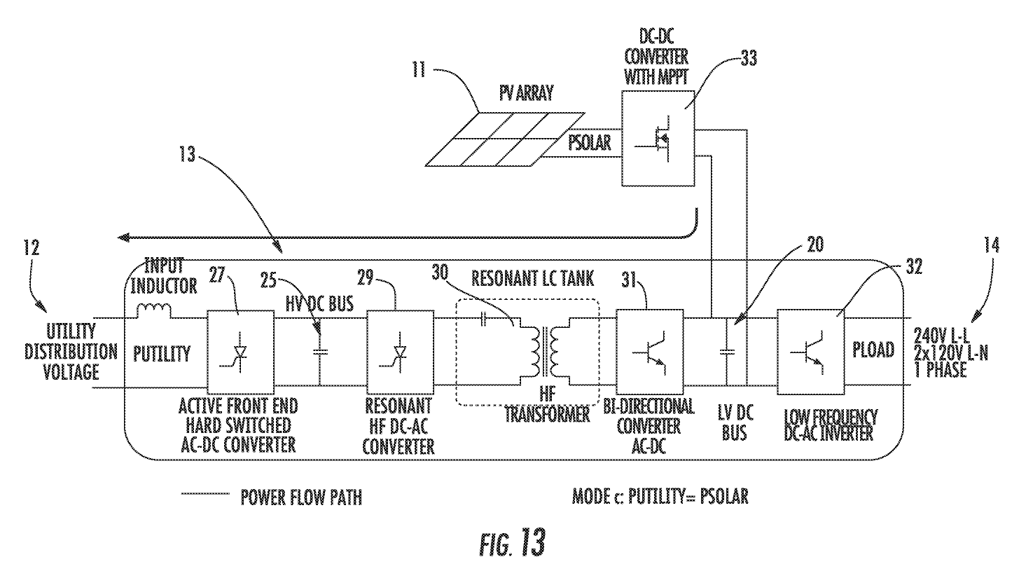

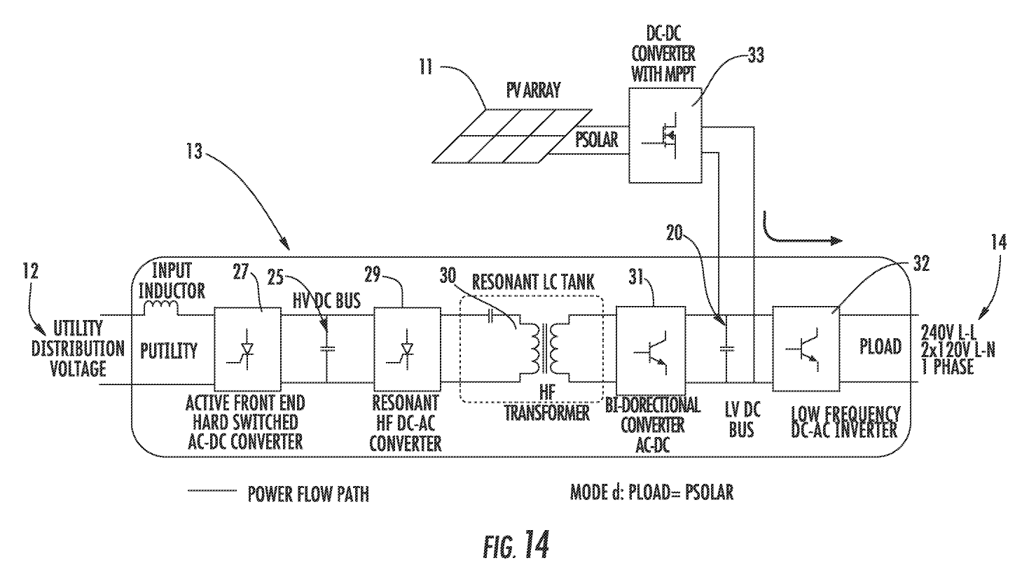

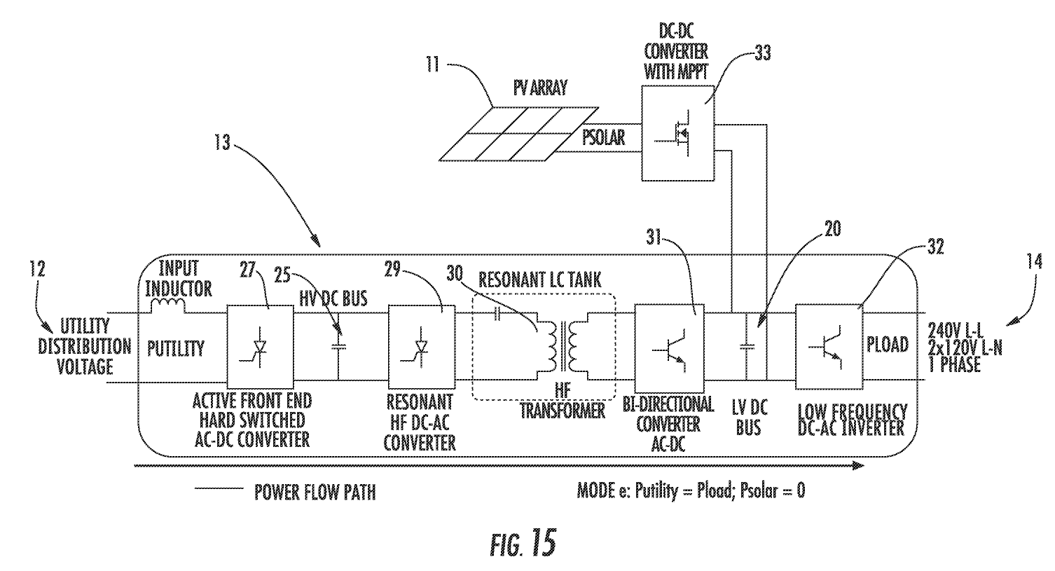

Referring to FIGS. 11-15, Putility, Psolar, Pload denote the distribution side power input into inverter, PV array power, and load power respectively. The IGCSI with a PV interface will have five main modes of operation:
a. Putility+Psolar=Pload, the utility 12 as well as the PV array 11 supplies power to the load 14 (FIG. 11).
b. Putility+Pload=Psolar, the PV array 11 supplies power to the load 14 and sends excess power back to utility 12 (grid-tie operation) (FIG. 12).
c. Putility=Psolar, the PV array 11 supplies the grid 12 through the transformer (grid-tie operation) (FIG. 13).
d. Psolar=Pload, the PV array 11 completely supplies the load 14 with no power drawn from the utility 12 (FIG. 14).
e. Putility=Pload, power is transferred from the utility 12 directly to the load 14 with no power output from PV array 11. This is standard distribution transformer functionality (FIG. 15).

The IGCSI 13 for PV integration mode includes:
a. An inverter that functions as a conventional transformer in absence of solar power.
b. An inverter that features a DC/DC converter with maximum power point tracking (MPPT) interface for integration of PV array to either the low voltage or the high voltage DC bus.
c. Control algorithms to synchronize power flow and implement the five main modes of operation specified earlier
d. All power stages are bi-directional to facilitate bi-directional power flow to and from the grid.
e. Diagnostic and communication interfaces to allow remote control and monitoring of the solar inverter.

### Operational Modes (Example: Energy Storage Integration)

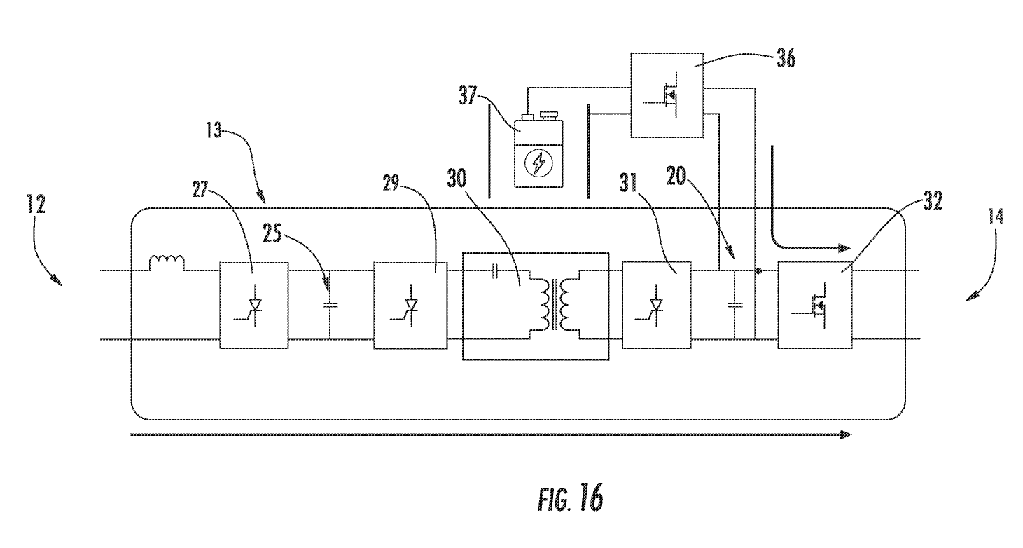

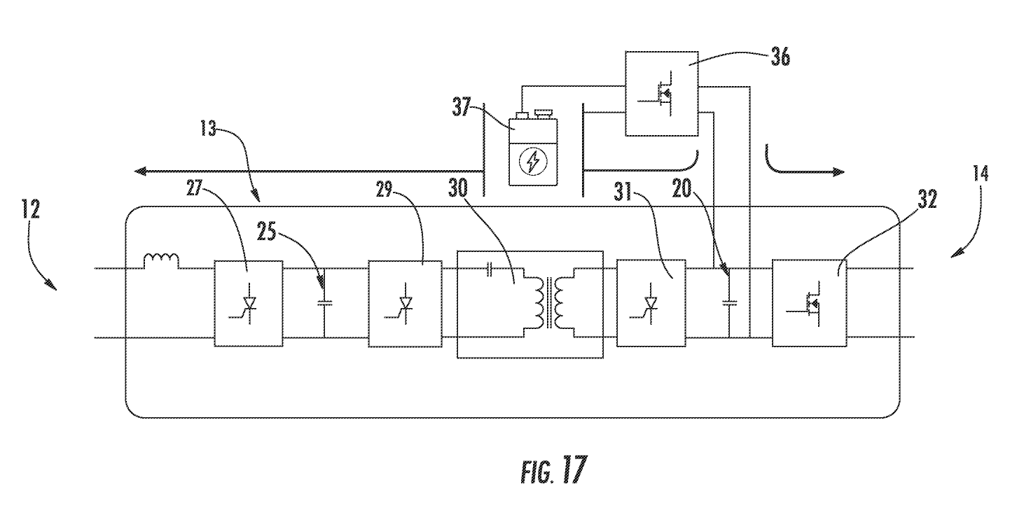

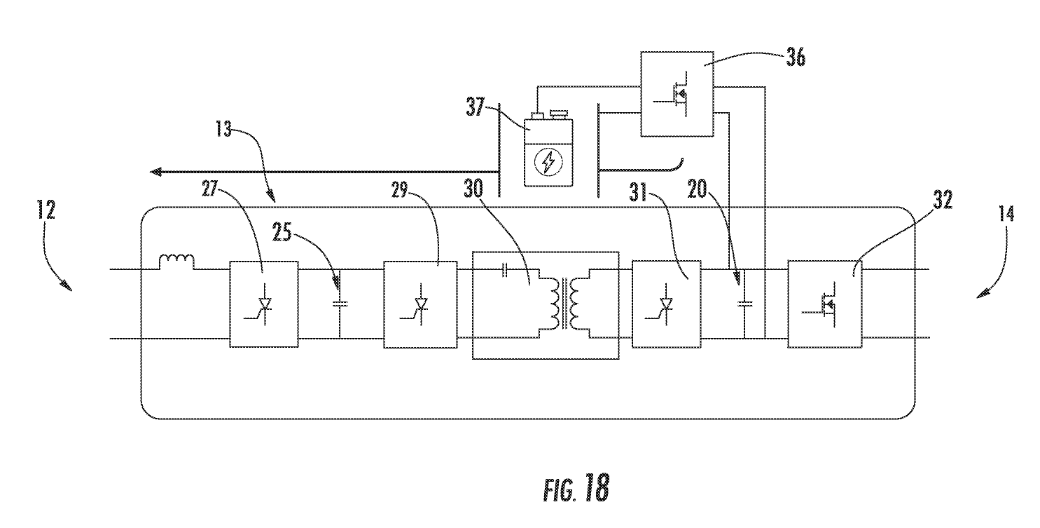

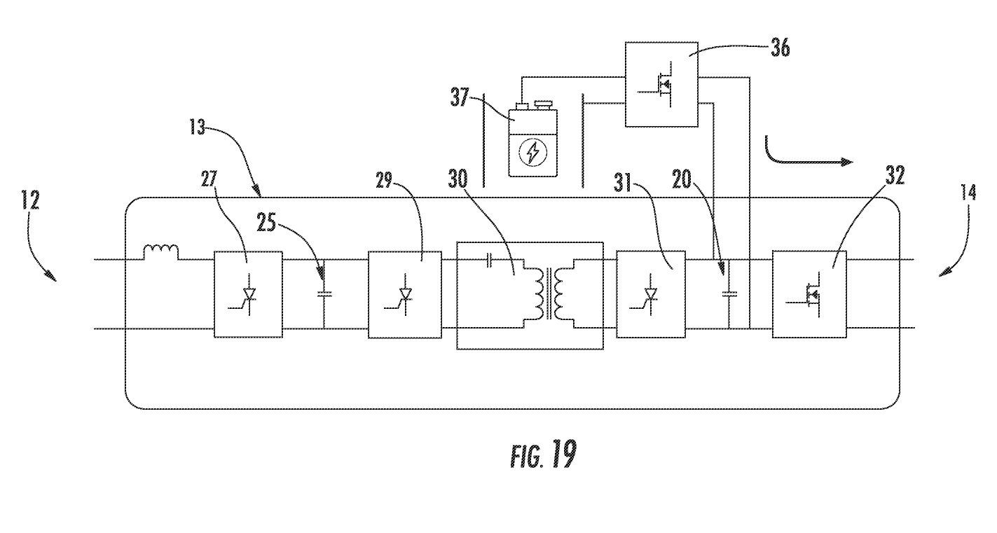

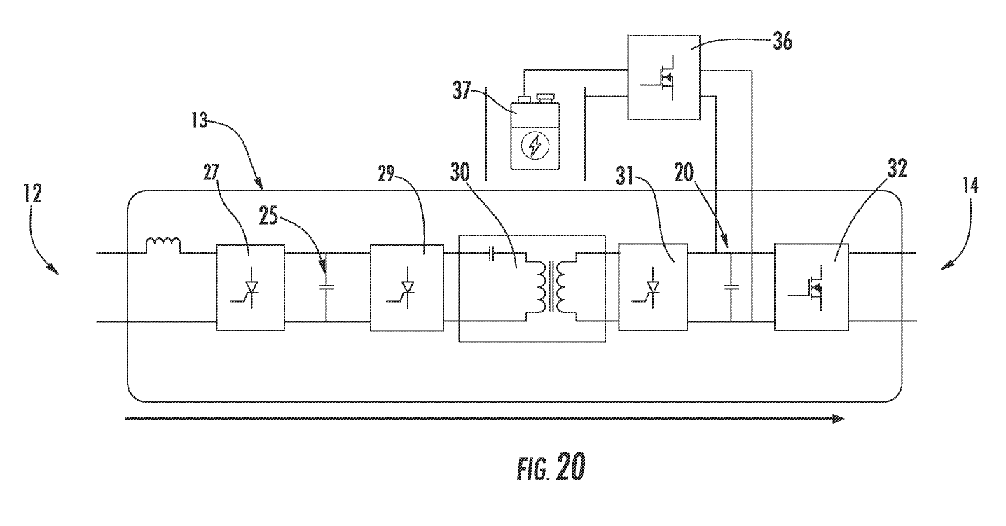

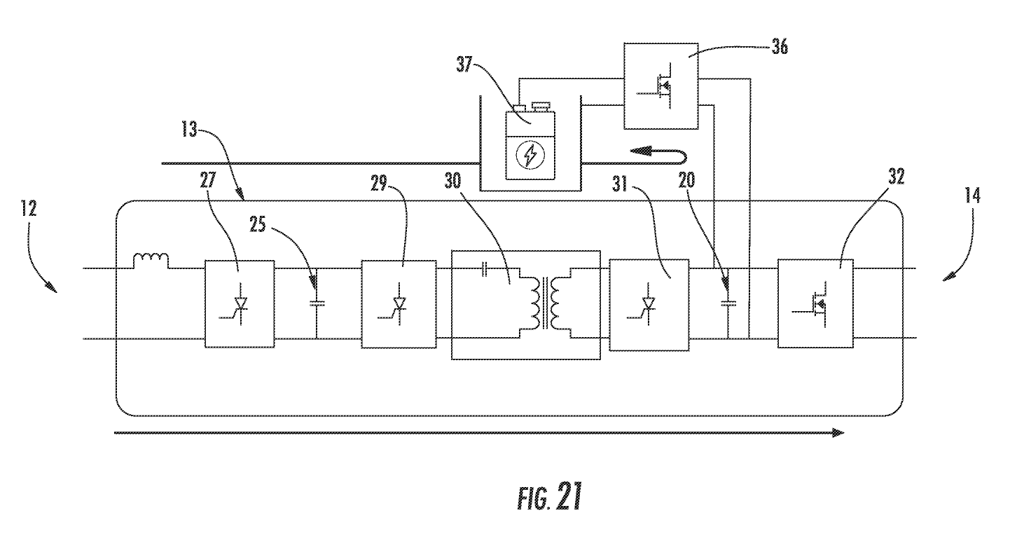

Similar modes exist for energy storage integration. FIGS. 16-21 show various IGCSI modes of operation for energy storage interfaces. These modes are as follows:
a. Putility+Pbatt=Pload, the utility 12 as well as the storage device 37 (i.e., battery) supplies power to the load 14 (FIG. 16).
b. Putility+Pload=Pbatt, the battery 37 supplies power to the load 14 and sends excess power back to utility 12 (grid-tie operation) (FIG. 17).
c. Putility=Pbatt, the battery 37 supplies the grid 12 through the transformer (grid-tie operation) (FIG. 18).
d. Pload=Pbatt, the battery 37 completely supplies the load 14 with no power drawn from the utility 12 (FIG. 19).
e. Putility=Pload, power is transferred from the utility 12 directly to the load 14 with no power output from battery 37. This is standard distribution transformer functionality (FIG. 20).
f. Putility=Pbatt+Pload, power is transferred from the utility 12 directly to the load 14 and to the battery 37 for charging (FIG. 21).

The foregoing has described an intelligent photovoltaic interface and system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A photo-voltaic interface for integration of photo-voltaic modules in a power system, comprising:
(a) a power conversion system adapted to convert power to a pre-determined voltage and current type;
(b) a control and monitoring system adapted to allow monitoring and control of power flow to optimize grid operation; and
(c) a communications system adapted to allow remote monitoring of the photo-voltaic interface to detect defective components.

2. The photo-voltaic interface according to claim 1, wherein the power conversion system converts AC power at low-voltage distribution voltages to 120 or 240 VAC.

3. The photo-voltaic interface according to claim 1, wherein the power conversion system converts DC power from photo-voltaic modules to 120 or 240 VAC.

4. The photo-voltaic interface according to claim 1, wherein the power conversion system converts DC power from photo-voltaic modules to low-voltage distribution voltage for export to a power network.

5. The photo-voltaic interface according to claim 1, wherein the control and monitoring system provides real-time advanced distribution automation and asset management.

6. The photo-voltaic interface according to claim 1, wherein the communication system is adapted to extract information selected from the group consisting of voltage, current, power factor, and temperature.

7. The photo-voltaic interface according to claim 1, wherein the photo-voltaic interface feeds power directly to a high-voltage distribution bus.

8. The photo-voltaic interface according to claim 1, wherein the photo-voltaic interface feeds power directly to a low-voltage distribution bus.

9. The photo-voltaic interface according to claim 1, wherein the power conversion system includes a cascade converter block having a hard switched AC-DC converter.

10. The photo-voltaic interface according to claim 9, wherein the cascade converter block converts 13.8 kV 60 Hz AC into a nominal 20 kV DC conversion at unity power factor.

11. The photo-voltaic interface according to claim 1, wherein the power conversion system includes a resonant converter block having:
(a) a resonant high frequency DC-AC converter;
(b) a resonant LC tank high frequency transformer; and
(c) a bi-directional AC-DC converter.

12. The photo-voltaic interface according to claim 11, wherein the resonant high frequency DC-AC converter provides isolation.

13. The photo-voltaic interface according to claim 11, wherein the resonant converter block includes a SuperGTO device with silicon-carbide based Schottky diodes.

14. The photo-voltaic interface according to claim 1, wherein the power conversion system includes an output converter block having at least one low frequency DC-AC inverter.

15. The photo-voltaic interface according to claim 1, wherein the power conversion system facilitates bi-directional power flow.

16. The photo-voltaic interface inverter according to claim 1, wherein the power conversion system includes a plurality of modules electrically connected to an output converter block, each module comprising:
(a) a cascade converter block having a hard switched AC-DC converter; and
(b) a resonant converter block having a resonant high frequency DC-AC converter, a resonant LC tank high frequency transformer, and a bi-directional AC-DC converter.

17. An intelligent photo-voltaic (PV) interface system, comprising:
(a) a utility grid adapted to provide AC power;
(b) a PV array adapted to provide DC power; and
(c) a photo-voltaic interface adapted to provide a direct interface with the PV array and the utility grid.

18. The intelligent photo-voltaic (PV) interface system according to claim 17, wherein the photo-voltaic interface includes a power conversion system adapted to convert power to a pre-determined voltage and current type, wherein the power conversion system facilitates bi-directional power flow to provide power to a load, the utility grid, or a storage device.

19. The intelligent photo-voltaic (PV) interface system according to claim 18, wherein the power conversion system includes:
(a) a cascade converter block having a hard switched AC-DC converter;
(b) a resonant converter block having a resonant high frequency DC-AC converter, a resonant LC tank high frequency transformer, and a bi-directional AC-DC converter; and
(c) an output converter block having at least one low frequency DC-AC inverter.
